(19) United States
(12) Patent Application Publication
(10) Pub. No.: US 2015/0078792 A1
(43) Pub. Date: Mar. 19, 2015

(54) BELT CONVEYANCE APPARATUS AND IMAGE FORMING APPARATUS

(71) Applicant: CANON KABUSHIKI KAISHA, Tokyo (JP)

(72) Inventors: Takaaki Aoyagi, Kawasaki-shi (JP); Yuri Mori, Tokyo (JP)

(21) Appl. No.: 14/485,564

(22) Filed: Sep. 12, 2014

(30) Foreign Application Priority Data
Sep. 18, 2013 (JP) 2013-193444

(51) Int. Cl. G03G 15/01

(52) U.S. Cl. CPC G03G 15/1615; G03G 15/6555; G03G 15/01
USPC 399/302

(57) ABSTRACT

A belt conveyance apparatus includes an endless belt and a plurality of rollers around which the belt is stretched, and receives an image on the endless belt at a predetermined image receiving surface in a conveyance direction of the belt. At least one of the plurality of rollers is a steering roller arranged on a downstream side of an image receiving position and capable of changing an arrangement angle thereof with respect to the belt by being tilted. If an area of the belt between the steering roller and the image receiving position in an opposite direction of the conveyance direction of the belt is assumed to be a predetermined area, a tilt axis of the steering roller is arranged on the predetermined area side of a rotational axis of the steering roller when viewing in the tilt axis direction.

### BACKGROUND OF THE INVENTION

1. Field of the Invention

The present invention relates to an image forming apparatus employing an electrophotographic method or an electrostatic recording method and including a belt conveyance apparatus.

2. Description of the Related Art

Conventionally, an electrophotographic image forming apparatus employs an endless belt (hereinafter also referred to as a belt) as a transfer material carrying member or an intermediate transfer member. More specifically, the intermediate transfer member carries a toner image transferred from a photosensitive member, and the transfer material carrying member carries and conveys a transfer material to which the toner image is transferred from the photosensitive member.

A large number of functions have been improved in the image forming apparatus which has employed the belt as the intermediate transfer member or the transfer material carrying member. For example, when the belt is employed as the intermediate transfer member, the toner images of a plurality of colors are superimposed on the belt. As a result, an electric resistance value of the transfer material such as a recording paper is less affected by a change in humidity, which is advantageous. However, when the image forming apparatus employs the belt, a change in a position of the belt in a width direction (i.e., deviation) when the belt is driven, or an error in a relative position of the belt in the width direction in an upstream portion and a downstream portion of the belt (i.e., meandering, skew, or inclination) may occur. Such a change or an error is characteristic when the belt is employed.

Deviation or meandering of the belt which occurs when the belt is driven is caused by mechanical accuracy of a belt driving mechanism or the belt itself, or a change in the characteristics of the belt. Further, the deviation or meandering is caused by various types of force applied from the outside such as vibration of the belt generated by the transfer material entering the belt serving as the transfer material carrying member, from a transfer material supplying mechanism. As a result, it is desirable to provide means for preventing deviation and meandering of the belt and correcting deviation and meandering which have occurred. Methods for correcting deviation or meandering of the belt will be described below.

Japanese Patent Application Laid-Open No. 2000-34031 discusses a method for correcting deviation or meandering of the belt by providing a steering roller capable of adjusting an arrangement angle with respect to the belt. Deviation or meandering of the belt is then corrected by adjusting the arrangement angle of the steering roller based on a detection result obtained by detecting the position of an edge of the belt in the width direction using a sensor. According to such a method, deviation of the belt in the width direction is caused to occur by tilting the steering roller so that the position of the belt in the width direction is controlled.

Further, Japanese Patent Application Laid-Open No. 2011-175012 discusses a method of disposing two sensors in the upstream and downstream portions of the steering roller and calculating the position of the belt in the width direction using detection values obtained by the two sensors. The error of the sensors caused by tilting of the steering roller is thus reduced.

However, according to the conventional method for correcting deviation and meandering of the belt discussed in Japanese Patent Application Laid-Open No. 2000-34031, the tilt of the steering roller itself causes the belt to move in the width direction.

In other words, there is a predetermined correlation between an amount of tilt of the steering roller and a moving speed of the belt in the width direction (i.e., a deviation speed), as will be described in detail below. As a result, if the steering roller is tilted when the belt is driven, the position of the belt in the width direction is changed (i.e., deviation is caused to occur) at the deviation speed according to the tilt amount of the steering roller. Such deviation speed does not correspond to the movement of the belt in the width direction caused by tilting of the steering roller itself described above. The movement of the belt in the width direction caused by tilting of the steering roller itself described above corresponds to the positional change of the belt caused by tilting of the steering roller itself even when the belt is not being driven.

Further, according to the method discussed in Japanese Patent Application Laid-Open No. 2011-175012, the effect of the error on the detection values of the sensors is reduced. However, the movement of the belt in the width direction caused by tilting of the steering roller itself continues to occur.

As described above, conventionally, when both the position and the deviation speed change due to tilting of the steering roller itself, it becomes difficult to perform accurate and stable control with respect to tilting of the steering roller. Further, if the movement of the belt in the width direction occurs due to tilting of the steering roller itself, a surface of the belt on which a plurality of colors of toner is to be matched moves in the width direction, so that color matching accuracy becomes degraded.

### SUMMARY OF THE INVENTION

According to an aspect of the present invention, a belt conveyance apparatus includes an image forming unit, a movable endless belt configured to receive an image from the image forming unit directly or via a transfer material on an image receiving surface, a plurality of rollers including a first roller and a second roller which stretch the image receiving surface on an upstream side and a downstream side of a moving direction of the belt, configured to stretch the belt, a steering roller configured to stretch a belt at a first position adjacent to the upstream side of the first roller or a second position adjacent to the downstream side of the second roller, and change a position of the belt in a width direction intersecting a moving direction of the belt by being tilted, and a tilting mechanism configured to tilt the steering roller around a tilt axis, wherein the tilt axis is arranged, in the case where an area of the belt from the steering roller to the image receiving surface in a conveyance direction of the belt is a predetermined area when the steering roller is arranged at the first position, or in the case where an area of the belt between the steering roller to the image receiving surface in an opposite direction of the conveyance direction of the belt is a predetermined area when the steering roller is arranged at the second position, on the predetermined area side of the belt from a rotational axis of the steering roller when viewing in a direction of the tilt axis.

According to another aspect of the present invention, an image forming apparatus including the above-described belt conveyance apparatus is provided.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an image forming apparatus.

FIG. 2 is a schematic cross-sectional view illustrating a sensor for detecting a deviation position of the intermediate transfer belt.

FIG. 3 is a perspective view illustrating a belt unit near the steering roller.

FIGS. 4A, 4B, and 4C are schematic diagrams illustrating a principle of a steering operation.

FIG. 5 is a graph illustrating a relation between the tilt amount of the steering roller and the deviation speed of the belt.

FIGS. 6A and 6B are schematic side views illustrating movement of the belt in the width direction caused by tilting of the steering roller itself.

FIG. 7 is an enlarged view illustrating a winding start position of the belt illustrating the movement of the belt in the width direction caused by the tilting of the steering roller itself.

FIG. 8 is a graph illustrating a detection error of the belt deviation speed in a comparison example.

FIG. 9 is a perspective view illustrating another example of the belt unit near the steering roller.

FIGS. 10A and 10B are schematic side views illustrating another example of the movement of the belt in the width direction caused by the tilting of the steering roller itself.

FIG. 11 is an enlarged view illustrating another example of the winding start position of the belt illustrating the movement of the belt in the width direction caused by tilting of the steering roller itself.

### DESCRIPTION OF THE EMBODIMENTS

Various exemplary embodiments, features, and aspects of the invention will be described in detail below with reference to the drawings.

### 1. Overall Configuration and Operation of the Image Forming Apparatus

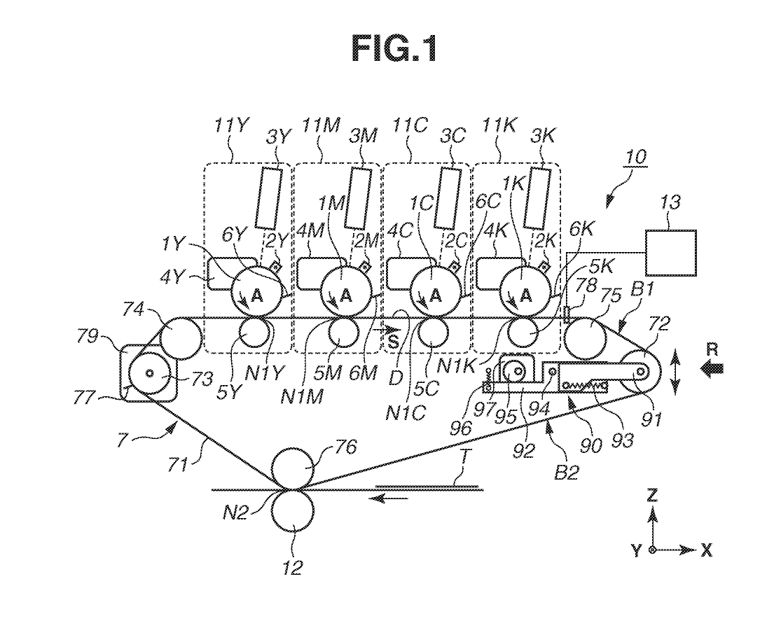

FIG. 1 is a schematic cross-sectional view illustrating an image forming apparatus according to a first exemplary embodiment of the present invention. Referring to FIG. 1, an image forming apparatus 10 is a tandem-type printer employing an intermediate transfer method, capable of forming a full color image according to the electrophotographic method. The image forming apparatus 10 performs operations to be described below based on a control signal received via a control interface.

The image forming apparatus 10 includes a plurality of image forming units 11Y, 11M, 11C, and 11K serving as serving as image forming units, along the conveyance direction of an image receiving surface D of an intermediate transfer belt 71 to be described below. The image forming units 11Y, 11M, 11C, and 11K respectively form yellow (Y), magenta (M), cyan (C), and black (K) images.

According to the present exemplary embodiment, the configurations and the operations of the image forming units 11Y, 11M, 11C, and 11K are substantially similar except for using different color toner. Therefore, unless it is necessary to discriminate between the image forming units, “Y”, “M”, “C”, and “K” at the end of reference numerals indicating the color of the image that the image forming unit is to form will be omitted, and the elements will be collectively described below.

The image forming unit 11 includes a photosensitive drum 1 which is a drum-type (or cylindrical) electrophotographic photosensitive member (or a photosensitive member) as the image bearing member. The photosensitive drum 1 is rotatably driven in a direction indicated by an arrow A illustrated in FIG. 1 by a driving motor (not illustrated) serving as serving as a driving unit. Each of the units to be described below is arranged around the photosensitive drum 1 in the following order along a rotational direction of the photosensitive drum 1. A corona charging device 2 serving as serving as a charging unit, an exposure device (or a laser scanner) 3 serving as serving as an exposure unit, a developing device 4 serving as serving as a developing unit, a primary transfer roller serving as serving as a roller-type primary transfer member as a primary transfer unit, and a drum cleaning device 6 serving as serving as a photosensitive member cleaning unit, are arranged around the photosensitive drum 1.

Further, a belt unit 7 is arranged to face the photosensitive drum 1 in each of the image forming units 11. The belt unit 7 includes the intermediate transfer belt 71 serving as serving as the intermediate transfer member, which is an endless belt, stretched around a plurality of tension rollers to be rotatable (i.e. rotatably movable). According to the present exemplary embodiment, the plurality of tension rollers includes a steering roller 72, a driving roller 73, a first driven roller 74, a second driven roller 75, a secondary transfer counter roller 76, and the primary transfer roller 5, to be described in detail below. The intermediate transfer belt 71 is conveyed (i.e., rotatably driven) in the direction indicated by an arrow S illustrated in FIG. 1. Each of the primary transfer rollers 5 is arranged at a position facing each of the photosensitive drums 1 on an inner circumferential surface side of the intermediate transfer belt 71. The primary transfer roller 5 is biased (pressed) towards the photosensitive drum 1 via the intermediate transfer belt 71, and forms a primary transfer portion N1 in which the intermediate transfer belt 71 and the photosensitive drum 1 contact each other. Further, a secondary transfer roller 12 serving as serving as a secondary transfer unit, which is a roller-shaped primary transfer member, is positioned facing the secondary transfer counter roller 76 on an outer circumferential surface side of the intermediate transfer belt 71. The secondary transfer roller 12 is biased (pressed) towards the secondary transfer counter roller 76 via the intermediate transfer belt 71, and forms a secondary transfer portion N2 in which the intermediate transfer belt 71 and the secondary transfer roller 12 contact each other. Furthermore, a belt cleaning device 77 i.e., an intermediate transfer member cleaning unit, is arranged at a position facing the driving roller 73 on the outer circumferential surface side of the intermediate transfer belt 71. The belt unit 7 is an example of the belt conveyance apparatus which receives the image at a predetermined receiving position on the belt in the conveyance direction of the belt, directly or via the transfer material on the belt.

When the image forming apparatus 10 forms an image, the corona charging device 2 substantially uniformly charges the surface of the rotating photosensitive drum 1 to a predetermined potential of a predetermined polarity. The laser scanner 3 then exposes the charged photosensitive drum 1 with light according to image information. As a result, an electrostatic image (i.e., an electrostatic latent image) is formed on the photosensitive drum 1, which is then developed by the developing device 4 using toner. The toner image is thus formed on the photosensitive drum 1. The developing device 4 includes a developing sleeve (not illustrated) serving as serving as a developer carrying member. The developing sleeve carries and conveys the toner serving as serving as the developer, to a portion facing the photosensitive drum 1 (i.e., a developing position), and develops the electrostatic latent image by applying a developing bias.

The toner image on the photosensitive drum 1 is transferred (primary transferred) to the intermediate transfer belt 71 by the primary transfer roller 5 at the primary transfer portion N1. In such a case, a primary transfer bias which is a direct current voltage of a polarity opposite to a charging polarity of the toner used when developing the image is applied to the primary transfer roller 5. The voltage is thus applied from a back surface of the intermediate transfer belt 71, and the toner image on the photosensitive drum 1 is transferred to the intermediate transfer belt 71. The drum cleaning device 6 removes and collects the toner remaining on the surface of the photosensitive drum 1 after the primary transfer is performed (i.e. primary transfer residual toner) from the surface of the photosensitive drum 1. More specifically, the drum cleaning device 6 uses a cleaning blade which contacts the photosensitive drum 1 and scrapes off and collects the primary transfer residual toner from the surface of the rotating photosensitive drum 1.

For example, when the image forming apparatus 10 is to form a full-color image, a similar image forming process is performed in each of the image forming units 11Y, 11M, 11C, and 11K. As a result, an image is formed on the intermediate transfer belt 71 by superimposing the yellow, magenta, cyan, and black toner images in order.

On the other hand, a transfer material T such as a recording paper is conveyed from a transfer material supplying unit (not illustrated) to the secondary transfer portion N2. The toner image on the intermediate transfer belt 71 is then transferred (secondary transferred) onto the transfer member T by the secondary transfer counter roller 76 and the secondary transfer roller 12 at the secondary transfer portion N2. In such a case, a secondary transfer bias which is the direct current voltage of the opposite polarity of the charging polarity of the toner when developing the image is applied to the secondary transfer roller 12. The belt cleaning device 77 removes and collects the toner remaining on the surface of the intermediate transfer belt 71 after the secondary transfer is performed (i.e. secondary transfer residual toner) from the surface of the intermediate transfer belt 71. More specifically, the belt cleaning device 77 uses the cleaning blade which contacts the intermediate transfer belt 71 and scrapes off and collects the secondary transfer residual toner from the surface of the rotating intermediate transfer belt 71.

The transfer material T to which the toner image has been transferred is separated from the intermediate transfer belt 71 and conveyed to a fixing device (not illustrated) serving as serving as a fixing unit. The fixing device then heats and presses the transfer material T and fixes the toner image on the surface of the transfer material T. The transfer material T on which the image has been fixed is discharged outside of the image forming apparatus 10 main body.

### 2. The Belt Unit

The belt unit 7 which is the belt conveyance apparatus according to the present exemplary embodiment will be described in detail below.

According to the present exemplary embodiment, a front side of the image forming apparatus 10 or the elements therein corresponds to a front side with respect to the page on which FIG. 1 is illustrated. Further, a rear side is the opposite side of the front side. Furthermore, a depth direction is the direction connecting the front side and the rear side. The depth direction is approximately parallel to a rotational axis direction of the tension rollers of the intermediate transfer belt 71. Moreover, the direction from the front side to the rear side along the depth direction will be referred to as a “+Y direction” and the opposite direction thereof as a “−Y direction”.

The belt unit 7 includes the intermediate transfer belt 71 serving as an endless belt (belt member or a belt body), and a plurality of tension rollers which are tension members serving as a tension unit. According to the present exemplary embodiment, the plurality of tension rollers includes the steering roller 72, the driving roller 73, the first driven roller 74, the second driven roller 75, the secondary transfer counter roller 76, and the primary transfer roller 5. The intermediate transfer belt 71 is stretched around the tension rollers to be rotatable.

The driving roller 73 is connected to a driving motor 79 serving as a driving unit. The intermediate transfer belt 71 is conveyed (rotatably driven) in the direction indicated by the arrow S illustrated in FIG. 1 by the driving roller 73 being rotationally driven by the driving motor 79.

The steering roller 72 is attached movably to the outer side of the intermediate transfer belt 71 to be by being pressed from the inner side by a tension spring 93. The steering roller 72 thus applies constant tension to the intermediate transfer belt 71.

Further, deviation and meandering of the intermediate transfer belt 71 can be controlled by arbitrarily changing the arrangement angle (i.e., alignment) of the steering roller 72 with respect to the intermediate transfer belt 71 as will be described in detail below. According to the present exemplary embodiment, the steering roller 72 is disposed on the downstream side of the primary transfer portion N1 (or a downstream-most primary transfer portion N1K) which is the image receiving position. The arrangement angle (i.e., alignment) of the steering roller 72 with respect to the intermediate transfer belt 71 is the arrangement angle of the steering roller 72 in the rotational axis direction with respect to the intermediate transfer belt 71, i.e., the angle in an out-of-plane deflection angle direction.

The first driven roller 74 and the second driven roller 75 hold the image receiving surface D in a constant horizontal state. The first driven roller 74 is disposed upstream of an upstream-most primary transfer portion N1Y in the image forming unit 11Y with respect to the conveyance direction of the intermediate transfer belt 71. The second driven roller 75 is disposed downstream of the downstream-most primary transfer portion N1K in the image forming unit 11K with respect to the conveyance direction of the intermediate transfer belt 71. The intermediate transfer belt 71 between the first driven roller 74 and the second driven roller 75 in the conveyance direction will be referred to as the image receiving surface D.

Further, according to the present exemplary embodiment, the belt unit 7 includes a sensor 78 serving as the detection unit, for detecting the position (i.e. a deviation position) of the intermediate transfer belt 71 in the width direction (i.e., the direction which is approximately perpendicular to the conveyance direction of the intermediate transfer belt 71). The sensor 78 is arranged to be capable of detecting the deviation position of the intermediate transfer belt 71 corresponding to the image receiving surface D. As a result, the position of the image receiving surface D in the width direction which affects color misregistration can be more accurately detected. In particular, according to the present exemplary embodiment, the sensor 78 is arranged between the steering roller 72 and a primary transfer roller 5K in the downstream-most image forming unit 11K nearest to the steering roller 72, in the vicinity of the upstream side of the second driven roller 75.

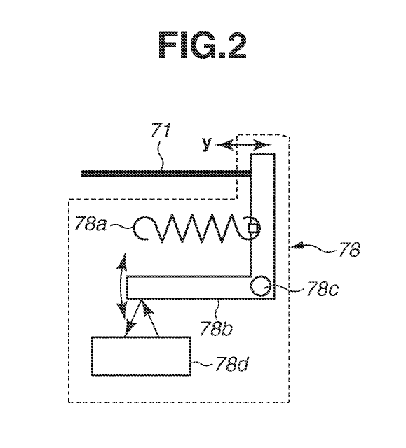

FIG. 2 is a schematic cross-sectional view illustrating the sensor 78. Referring to FIG. 2, one end of a contactor 78b is held in a press-contacting state with respect to an edge of the intermediate transfer belt 71 in the width direction (i.e., the rear side according to the present exemplary embodiment) by tensile force of a spring 78a. In such a case, the press-contacting force of the contactor 78b by the spring 78a is set to an appropriate strength so as to not deform the intermediate transfer belt 71. Further, a spindle 78c rotatably-supports an intermediate portion of the contactor 78b. Furthermore, a displacement sensor 78d, which is a reflection-type photo sensor, is arranged facing the contactor 78b at the other end of the contactor 78b with respect to the spindle 78c as a border. In the sensor 78, the change in the position of the intermediate transfer belt 71 in the width direction (y-direction in FIG. 2) is converted into the movement (i.e., a swinging operation) of the contactor 78b press-contacting the edge of the intermediate transfer belt 71. In such a case, an output level of the displacement sensor 78d changes according to the movement (displacement) of the contactor 78b, so that the position of the intermediate transfer belt 71 in the width direction can be continuously detected based on the sensor output. The method for detecting the position of the belt in the width direction is not limited to arranging a contact-type sensor at the edge portion of the belt in the width direction as described above. For example, a mark drawn on the belt (which is previously formed or formed by the toner) may be read using a non-contacting type sensor from above the belt.

According to the present exemplary embodiment, the belt unit 7 serving as the belt conveyance apparatus, includes the intermediate transfer belt 71, the plurality of tension rollers 72, 73, 74, and 75, the belt cleaning device 77, the sensor 78, and a steering mechanism 90 to be described below.

### 3. The Steering Mechanism

As described above, if the endless belt is stretched around the plurality of rollers and rotated, a deviation force of the roller in the rotational axis direction is applied on the belt. As a result, the belt is displaced in the rotational axis direction of the roller (i.e., the width direction of the belt) to reach a more stable rotational position. To solve such a problem, there is a belt steering method for stably rotating the endless belt in a constant course. In other words, at least one of the rollers among the rollers around which the belt is stretched is configured as the steering roller capable of being tilted. Further, the position of the belt in the width direction (i.e., the deviation position) is detected. A tilt direction and the tilt amount of the steering roller are then adjusted based on the detected information, so that deviation and meandering of the belt are corrected.

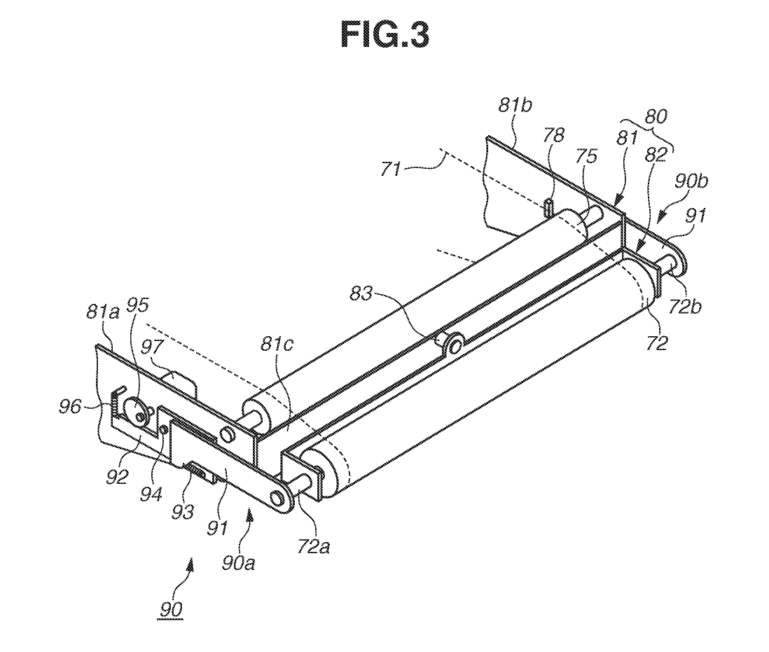

FIG. 3 is a perspective view illustrating the belt unit 7 near the steering roller 72 indicating the steering mechanism 90 (i.e., a front side steering mechanism 90a and a rear side steering mechanism 90b) according to the present exemplary embodiment.

Referring to FIG. 3, according to the present exemplary embodiment, a supporting frame 80 supporting the tension rollers in the belt unit 7 includes a frame main body (i.e., a first supporting portion) 81 and a holder (i.e., a second supporting portion) 82. The frame main body 81 supports all of the tension rollers except for the steering roller 72, and the holder 82 supports the steering roller 72. The frame main body 81 includes a front side side-plate 81a and a rear side side-plate 81b arranged to be substantially parallel to each other, and a beam 81c arranged between the front side side-plate 81a and the rear side side-plate 81b. The holder 82 is attached to the beam 81c to be capable of being tilted on the beam 81c arranged near the downstream side of the second driven roller 75. According to the present exemplary embodiment, the steering mechanism 90 (i.e., the front side steering mechanism 90a and the rear side steering mechanism 90b) tilts the holder 82 with respect to the frame main body 81, and thus tilts the steering roller 72.

The front side steering mechanism 90a will be described below. The front side steering mechanism 90a includes an arm 91, an arm support member 92, a tension spring 93, an arm shaft 94, a cam 95, a steering spring 96, and a steering motor 97.

A front side rotational shaft end portion 72a of the steering roller 72 is rotatably-supported by the holder and the arm 91. The arm 91 is supported by the arm support member 92 to be slidable in a longitudinal direction of the arm 91 via a slide rail (not illustrated). The arm 91 is biased in the direction in which the steering roller 72 presses the intermediate transfer belt 71 from an inner side to an outer side, by the tension spring 93 disposed between the arm 91 and the arm support member 92. The arm support member 92 is supported by the front side side-plate 81a to be rotatable around the arm shaft 94. The cam 95 is configured to be rotatable by the steering motor 97 fixed to the front side side-plate 81a. Further, the steering spring 96 causes the side of the arm support member 92 which is the opposite side of the steering roller 72 with respect to the arm shaft 94 to contact the cam 95. Furthermore, the holder 82 includes a steering shaft 83. The steering shaft 83 is rotatably attached to the beam 81c fixed between the front side side-plate 81a and the rear side side-plate 81b, and to be capable of performing translational motion in the rotational axis direction thereof. The arm support member 92 rotates around the arm shaft 94 by rotation of the cam 95. As a result, the arrangement angle of the arm 91 around the arm shaft 94 changes while the arm 91 applies constant tension to the intermediate transfer belt 71 by the force of the tension spring 93. Thus, the arrangement angle of the steering roller 72 with respect to the intermediate transfer belt 71 can be adjusted.

On the other hand, the rear side steering mechanism (or support mechanism) 90b having a similar configuration as the front side steering mechanism 90a is arranged on a rear side rotational axis end portion 72b side of the steering roller 72. The rear side steering mechanism 90b includes the arm 91, an arm support member (not illustrated), an arm shaft (not illustrated), and a tension spring (not illustrated), similarly as the front side steering mechanism 90a. Further, the rear side steering mechanism 90b rotates around the arm shaft 94 according to the tilt of the steering roller 72 and applies the tensile force to the intermediate transfer belt 71 using the tension spring 93.

According to the present exemplary embodiment, the front side steering mechanism 90a and the rear side steering mechanism 90b are capable of tilting the steering roller 72 while maintaining the tensile force of the intermediate transfer belt 71 in the width direction to be approximately uniform.

### 4. The Steering Operation

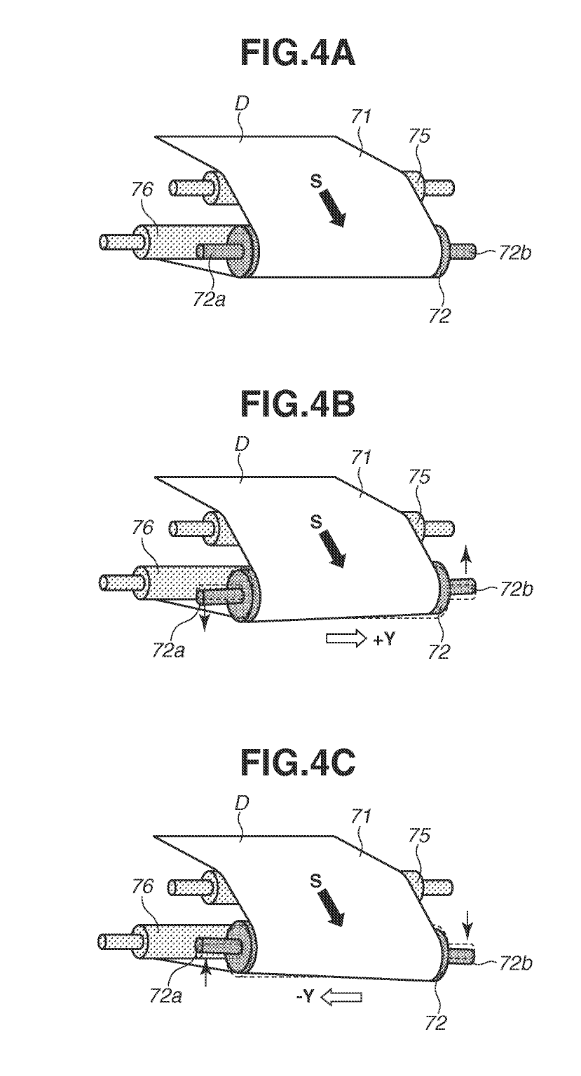

The general principle on the relation between the tilt of the steering roller 72 and deviation of the intermediate transfer belt 71 will be described below with reference to FIGS. 4A, 4B, and 4C. FIGS. 4A, 4B, and 4C are schematic perspective views illustrating the vicinity of the steering roller 72 illustrating the change in the deviation position of the intermediate transfer belt 71 due to tilting of the steering roller 72.

In a state illustrated in FIG. 4A, the steering roller 72 is aligned substantially parallel to the image receiving surface D. In other words, the second driven roller 75, the steering roller 72, and the secondary transfer counter roller 76 are aligned substantially parallel to each other. In such a state, the rotational direction of each roller and a winding direction of the intermediate transfer belt 71 are approximately the same (i.e., a winding start position and end position of the intermediate transfer belt 71 with respect to the rotational axis direction of each roller are approximately the same). In such a case, the intermediate transfer belt 71 does not move in the rotational axis direction of the steering roller 72 (i.e., the width direction of the intermediate transfer belt 71) on the steering roller 72.

The states illustrated in FIGS. 4B and 4C, the steering roller 72 is tilted with respect to the image receiving surface D. In other words, the steering roller 72 is tilted with respect to the second driven roller 75 and the secondary transfer counter roller 76. In such a case, the winding start position and end position of the intermediate transfer belt 71 with respect to the steering roller 72 are displaced in the rotational axis direction of the steering roller 72.

More specifically, in the state illustrated in FIG. 4B, the steering roller 72 is tilted so as to lower the front side end portion 72a of the steering roller 72. In such a case, the intermediate transfer belt 71 being conveyed in the direction indicated by the arrow S illustrated in FIG. 4B moves in the +Y direction as indicated by the arrow illustrated in FIG. 4B along the rotational axis direction of the steering roller 72. Further, in the state illustrated in FIG. 4C, the steering roller 72 is tilted so as to raise the front side end portion 72a of the steering roller 72. In such a case, the intermediate transfer belt 71 being conveyed in the direction indicated by the arrow S illustrated in FIG. 4C moves in the −Y direction as indicated by the arrow illustrated in FIG. 4C along the rotational axis direction of the steering roller 72.

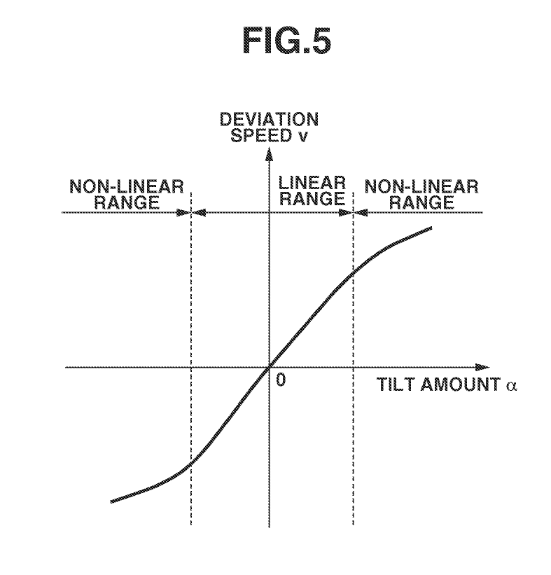

The displacement of intermediate transfer belt 71 in the rotational axis direction on the steering roller 72 increases as the tilt of the steering roller 72 increases. Therefore, the relation between the tilt amount (i.e., an alignment amount) a, which is an angle from the tilt of the steering roller 72 illustrated in FIG. 4A as the basis, and a belt deviation speed v of the intermediate transfer belt 71 in the rotational axis direction of the steering roller 72 becomes as illustrated in FIG. 5. Referring to FIG. 5, if the tilt of the steering roller 72 becomes large, constant slipping occurs between the intermediate transfer belt 71 and the steering roller 72, so that linearity is deteriorated as the tilt amount a increases.

According to the above-described principle, deviation and meandering of the intermediate transfer belt 71 caused by the outside force applied on the intermediate transfer belt 71 can be reduced by generating the deviation speed which cancels such deviation and meandering by the steering roller 72.

According to the present exemplary embodiment, deviation and meandering of the intermediate transfer belt 71 are controlled as follows. A target value with respect to the detection result of the sensor 78 is set to a controller 13 serving as a control unit illustrated in FIG. 1. The controller 13 causes the steering mechanism 90 to operate so as to generate the deviation speed so that the detection result of the sensor 78 approaches the target value thereof, and controls the arrangement angle of the steering roller 72. The controller 13 performs such control based on the relation illustrated in FIG. 5. In such a case, deviation and meandering of the intermediate transfer belt 71 are basically controlled by the tilt of the steering roller 72 within a linear range of the relation between the tilt amount a and the deviation speed.

According to the present exemplary embodiment, the second driven roller 75 is arranged between the steering roller 72 and the sensor 78. A height of the image receiving surface D thus does not change due to tilting of the steering roller 72, so that color misregistration and noise in the sensor 78 can be reduced.

### 5. The Positional Change Caused by the Steering Operation Itself

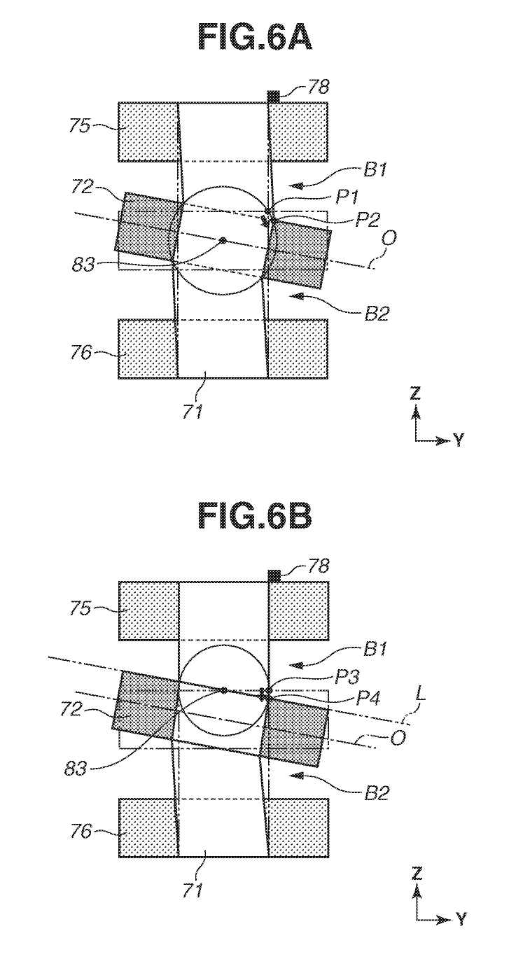

The movement (i.e., the positional change) of the intermediate transfer belt 71 in the width direction caused by tilting of the steering roller 72 (i.e., the steering operation) itself will be described below with reference to FIGS. 6A and 6B.

FIGS. 6A and 6B are schematic side views illustrating the vicinity of the steering roller 72 as viewed from the direction indicated by an arrow R illustrated in FIG. 1. The direction indicated by the arrow R illustrated in FIG. 1 is an axial direction of the steering shaft 83, i.e., a tilt axis direction of the steering roller 72. According to the present exemplary embodiment, the direction indicated by the arrow R illustrated in FIG. 1 is substantially parallel with the image receiving surface D. In FIGS. 6A and 6B, only an area in a circumferential direction in which the intermediate transfer belt 71 is wound is indicated with respect to the steering roller 72.

According to the present exemplary embodiment, the steering roller 72 is disposed on the downstream side of the primary transfer portion N1 (more specifically, the downstream-most primary transfer portion N1K) which is the image receiving position. In such a case, a “predetermined area” of the belt according to the present invention corresponds to the area of the intermediate transfer belt from the steering roller 72 to the primary transfer portion N1 (more specifically, the downstream-most primary transfer portion N1K) in the opposite direction of the conveyance direction of the intermediate transfer belt 71. However, according to the present exemplary embodiment, the area of the intermediate transfer belt 71 between the steering roller 72 and the driving roller 73 of the side in which the primary transfer roller 5 is arranged will be defined as “a primary transfer area B1” for ease of description. The primary transfer area B1 is the area including the predetermined area of the belt according to the present invention. Further, according to the present exemplary embodiment, the area of the intermediate transfer belt 71 between the steering roller 72 and the driving roller 73 of the side in which the secondary transfer counter roller 76 is arranged will be defined as “a secondary transfer area B2”. The secondary transfer area B2 is the area which does not include the predetermined area of the belt according to the present invention.

Referring to FIG. 6A, which is a comparison example, the steering shaft 83 (i.e., the tilt axis of the steering roller 72) is arranged at the position which is substantially the same as a rotational axis O of the steering roller 72. In such a case, if the steering roller tilts, the winding start position of the intermediate transfer belt 71 with respect to the steering roller 72 is moved from approximately a position P1 to a position P2. As a result, the primary transfer area B1 is moved in the +Y direction by tilting of the steering roller 72 itself.

On the other hand, referring to FIG. 6B, the steering shaft 83 (i.e., the tilt axis of the steering roller 72) is arranged on the primary transfer area B1 side from the rotational axis O of the steering roller 72. In particular, in the configuration illustrated in FIG. 6B, the steering shaft 83 is arranged at a position which is substantially the same as a line L (hereinafter referred to as a winding start generatrix) formed at the winding start position of the intermediate transfer belt 71 with respect to the steering roller 72 on the primary transfer area B1 side. In such a case, if the steering roller 72 tilts, the winding start position of the intermediate transfer belt 71 with respect to the steering roller 72 is moved from approximately a position P3 to a position P4.

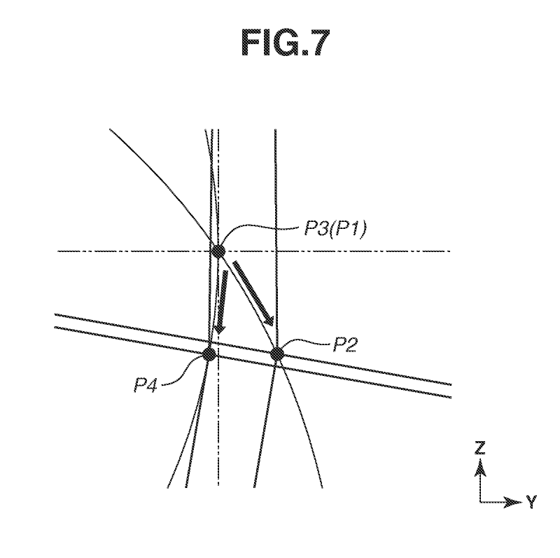

FIG. 7 is an enlarged view illustrating a comparison of differences in the movement of the winding start position between the configuration illustrated in FIG. 6A and the configuration illustrated in FIG. 6B. Referring to FIG. 7, the position P1 and the position P3 before the winding start position is moved are the same in each configuration. However, the displacement of the positions (P2 and P4) after the movement with respect the positions (P1 and P3) before the movement in the width direction of the intermediate transfer belt 71 is considerably small according to the configuration illustrated in FIG. 6B as compared to the configuration of FIG. 6A. In other words, the configuration illustrated in FIG. 6B can greatly reduce the movement of the primary transfer area B1 in the width direction of the intermediate transfer belt 71 as compared to the configuration illustrated in FIG. 6A.

### 6. Advantageous Effect

The effects of controlling deviation and meandering of the intermediate transfer belt 71 by the arrangement of the steering shaft 83 according to the present exemplary embodiment will be described below.

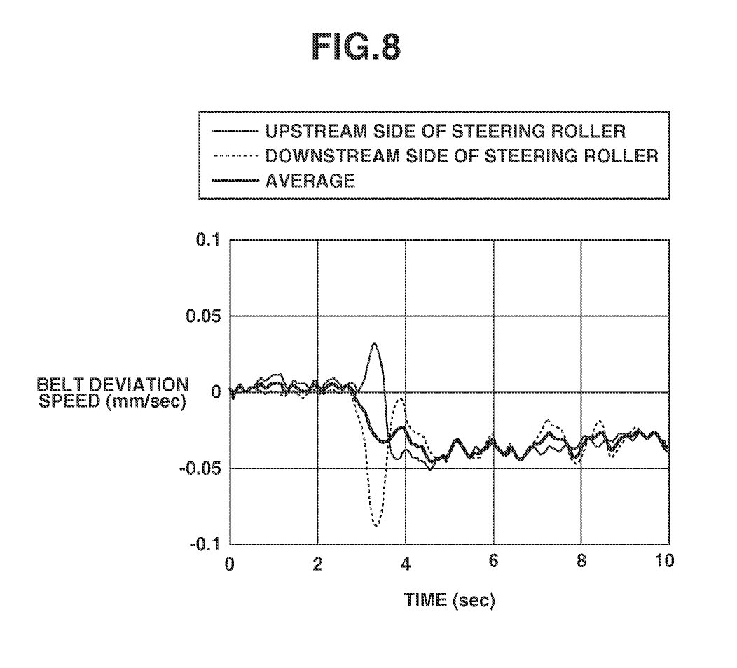

FIG. 8 illustrates the results of detecting the deviation speed of the intermediate transfer belt 71 when the steering roller 72 is tilted in the configuration illustrated in FIG. 6A (i.e., the steering shaft 83 is arranged in the position which is substantially the same as the rotational axis O of the steering roller 72). Time is indicated on a horizontal axis, and the deviation speed is indicated on a vertical axis.

Referring to FIG. 8, the detection results obtained by the sensor 78 arranged on the upstream side of the steering roller 72 illustrated in FIG. 6A and a similar sensor (not illustrated) arranged on the downstream side of the steering roller 72 are illustrated. Further, an average value of the above-described detection results is illustrated in FIG. 8. In addition, the steering roller 72 is tilted stepwise at approximately three seconds on the horizontal axis in FIG. 8. Moreover, a positive value on the vertical axis illustrated in FIG. 8 indicates the deviation speed in the +Y direction and a negative value indicates the deviation speed in the −Y direction as illustrated in FIGS. 6A and 6B.

The average values of the detection results obtained by the two sensors illustrated in FIG. 8 indicate that the intermediate transfer belt 71 starts to move in the −Y direction immediately after the steering roller 72 has tilted. However, the sensor 78 arranged on the upstream side detects that the intermediate transfer belt once moves in the +Y direction immediately after the steering roller 72 has tilted.

If the sensor detects that the intermediate transfer belt 71 has moved in the width direction due to the steering operation itself as described above, it may cause an error in controlling deviation and meandering of the intermediate transfer belt 71. The steering operation itself may thus disturb deviation and meandering of the intermediate transfer belt 71 to be controlled.

Further, the movement of the intermediate transfer belt 71 in the width direction due to the steering operation itself may become a disturbance with respect to the primary transfer area B1 in which the plurality of colors of toner are matched. The accuracy in color matching may thus be lowered.

Furthermore, the direction in which the intermediate transfer belt 71 is forced to move in the width direction at the moment the steering roller 72 is tilted is opposite to a usual deviation direction of the intermediate transfer belt 71. In other words, if the tilt direction is as illustrated in FIG. 6A, the usual direction of the deviation speed is the −Y direction. However, the intermediate transfer belt 71 is forced to be moved in the +Y direction immediately after the steering roller 72 is tilted. As a result, control of deviation and meandering of the intermediate transfer belt 71 may become less accurate or unstable.

On the other hand, according to the configuration illustrated in FIG. 6B (i.e., the steering shaft 83 is arranged on the primary transfer area B1 side from the rotational axis O of the steering roller 72), the steering roller 72 can be tilted with little movement of the primary transfer area B1 in the width direction. As a result, the deviation speed of the intermediate transfer belt 71 can be singularly controlled to be of an arbitrary value. Deviation and meandering of the intermediate transfer belt can thus be stably controlled, and the effect on the color misregistration due to the steering operation can be reduced.

According to the present exemplary embodiment, the steering shaft 83 is arranged on the winding start generatrix L of the intermediate transfer belt 71 with respect to the steering roller 72. However, the present invention is not limited thereto, and the steering shaft 83 may be offset to the primary transfer area B1 side from the rotational axis O of the steering roller 72. In other words, according to the present invention, it is only necessary that the tilt axis of the steering roller 72 is arranged on the predetermined area side of the belt from the rotational axis of the steering roller 72 when viewing in the tilt axis direction of the steering roller 72. If an offset amount is too large, it may increase the disturbance caused by the steering operation. In general, it is desirable to arrange the tilt axis of the steering roller 72 on the steering roller side from the roller adjacent to the steering roller on the image receiving position side when viewing in the tilt axis direction of the steering roller 72. Further, it is most desirable to arrange the tilt axis of the steering roller 72 at the position which is approximate the same as the winding start generatrix L of the intermediate transfer belt 71 with respect to the steering roller 72 when viewing in the tilt axis direction of the steering roller. This is as described in the present exemplary embodiment.

According to the present exemplary embodiment, if the steering shaft 83 is offset to the primary transfer area B1 side from the rotational axis O of the steering roller 72, the displacement of the secondary transfer area B2 in the width direction due to the steering operation itself becomes greater as compared to the configuration illustrated in FIG. 6A. However, as described above, according to the present exemplary embodiment, the disturbance with respect to the sensor 78 arranged in the primary transfer area B1 can be reduced, and the disturbance with respect to controlling deviation and meandering of the intermediate transfer belt 71 can be reduced. Further, since it is necessary to prevent the accuracy of color matching to become low in the primary transfer, position accuracy required in the primary transfer is stricter as compared to the position accuracy required in the secondary transfer. In this point, according to the present exemplary embodiment, the movement of the primary transfer area B1 can be reduced, so that the color matching accuracy is prevented from becoming low. Furthermore, a distance between the steering roller 72 and the secondary transfer portion N2 (i.e., the secondary transfer roller 12 and the secondary transfer counter roller 76) can be set comparatively long. As a result, the movement of the intermediate transfer belt 71 in the width direction near the steering roller 72 has little effect on the vicinity of the secondary transfer portion N2. As described above, according to the present exemplary embodiment, it is advantageous to offset the steering shaft 83 to the primary transfer area B1 side from the rotational axis O of the steering roller 72.

According to the present exemplary embodiment, the effect of the movement of the intermediate transfer belt 71 in the width direction caused by tilting of the steering roller 72 itself on the image can be reduced. In particular, according to the present exemplary embodiment, the disturbance on the sensor 78 arranged in the primary transfer area B1 is reduced so that the accuracy of controlling deviation and meandering of the intermediate transfer belt 71 can be improved. Further, color misregistration caused by the steering operation can be reduced.

A second exemplary embodiment of the present invention will be described below. The basic configurations and operations of the belt conveyance apparatus and the image forming apparatus according to the present exemplary embodiment are similar to those according to the first exemplary embodiment. The functions and the elements having the configurations which are similar or correspond to those according to the first exemplary embodiment will thus be assigned the same reference numerals, and detailed description will be omitted.

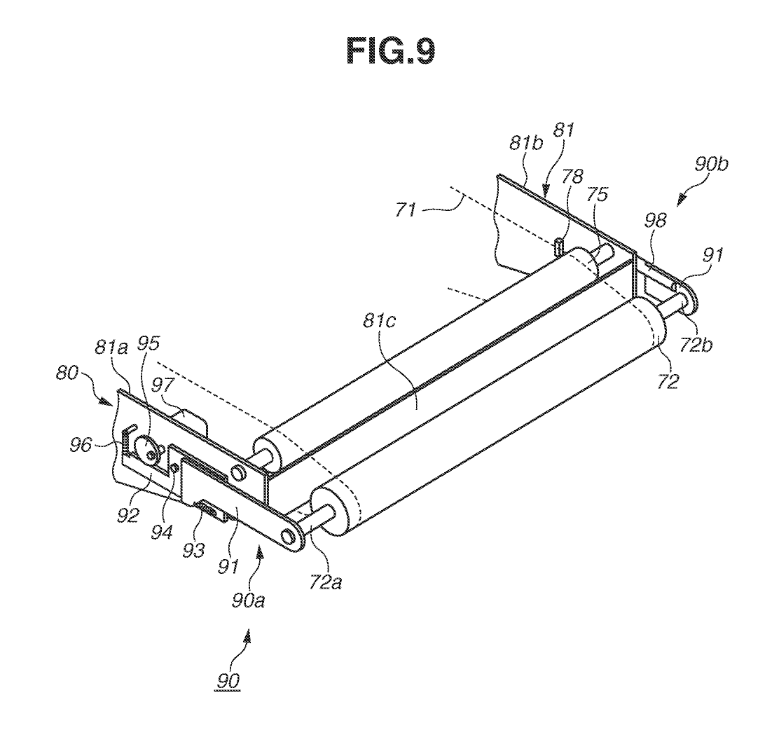

FIG. 9 is a perspective view illustrating the belt unit 7 near the steering roller 72 indicating the steering mechanism 90 (i.e., the front side steering mechanism 90a and the rear side steering mechanism 90b) according to the present exemplary embodiment.

According to the present exemplary embodiment, the supporting frame 80 which supports the tension rollers in the belt unit 7 does not include the holder 82 as in the first exemplary embodiment, and includes the frame main body 81 similarly as in the first exemplary embodiment. Further, according to the present exemplary embodiment, the steering roller 72 is rotatably supported by the arm 91 of the front side steering mechanism 90a and the rear side steering mechanism 90b attached to the frame main body 81 to be described below.

The configuration of the front side steering mechanism 90a according to the present exemplary embodiment is similar to that according to the first exemplary embodiment. On the other hand, the rear side steering mechanism (or a supporting mechanism) 90b supporting the rear side rotational shaft end portion 72b of the steering roller 72 includes the arm 91, a steering shaft 98, and a tension spring (not illustrated). The rear side steering mechanism 90b is biased by the tension spring in the direction in which the steering roller 72 presses the intermediate transfer belt 71 from the inner side to the outer side. As a result, the rear side steering mechanism 90b applies approximately constant tensile force to the intermediate transfer belt 71 in the width direction along with the front side steering mechanism 90a. Further, the rear side rotational shaft end portion 72b of the steering roller 72 is rotatably attached to the arm 91 in the rear side steering mechanism 90b, and the arm 91 rotates around the steering shaft 98.

According to the present exemplary embodiment, the steering roller 72 thus tilts around the steering shaft 98 positioned at the rear side rotational shaft end portion 72b of the steering roller 72, along with the operation of the front side steering mechanism 90a by the above-described configuration.

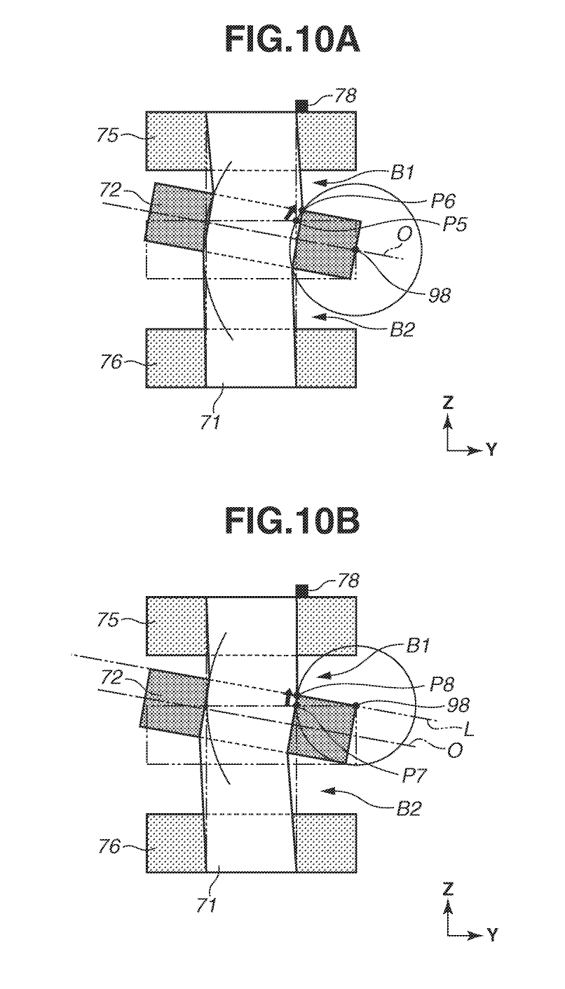

The movement (i.e., the positional change) of the intermediate transfer belt 71 in the width direction caused by tilting of the steering roller 72 (i.e., the steering operation) itself will be described below with reference to FIGS. 10A and 10B.

FIGS. 10A and 10B are schematic side views illustrating the vicinity of the steering roller 72 as viewed from the direction indicated by the arrow R illustrated in FIG. 1. Referring to FIGS. 10A and 10B, only the area in the circumferential direction in which the intermediate transfer belt 71 is wound is illustrated with respect to the steering roller 72.

Referring to FIG. 10A, i.e., a comparison example, the steering shaft 98 (i.e., the tilt axis of the steering roller 72) is arranged at the position which is approximately the same as the rotational axis O of the steering roller 72. In such a case, if the steering roller tilts, the winding start position of the intermediate transfer belt 71 with respect to the steering roller 72 is moved from approximately a position P5 to a position P6. As a result, the primary transfer area B1 is moved in the +Y direction.

On the other hand, referring to FIG. 10B, the steering shaft 98 (i.e., the tilt axis of the steering roller 72) is arranged on the primary transfer area B1 side from the rotational axis O of the steering roller 72. In particular, the steering shaft 98 is arranged at the position which is approximately the same as an extension of the line L (i.e., the winding start generatrix) formed at the winding start position of the intermediate transfer belt 71 with respect to the steering roller 72 on the primary transfer area B1 side. In such a case, if the steering roller 72 tilts, the winding start position of the intermediate transfer belt 71 with respect to the steering roller 72 is moved from approximately a position P7 to a position P8.

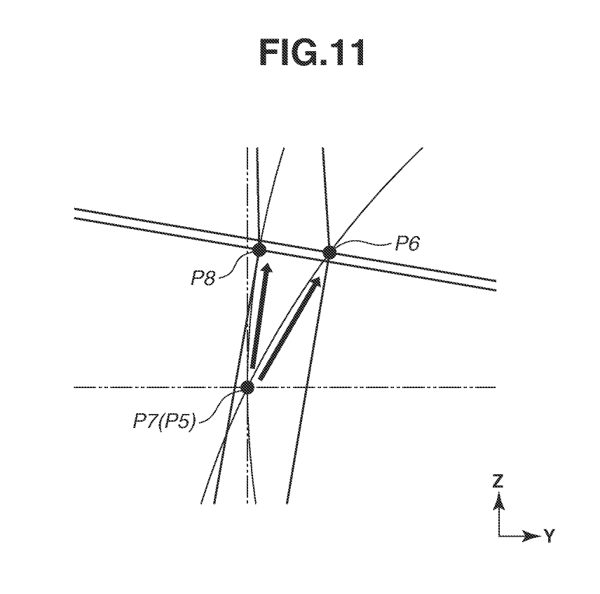

FIG. 11 is an enlarged view illustrating a comparison of differences in the movement of the winding start position between the configuration illustrated in FIG. 10A and the configuration illustrated in FIG. 10B. Referring to FIG. 11, the position P5 and the position P7 before the winding start position is moved are the same position in each configuration. However, the displacement of the positions (P6 and P8) after the movement with respect the positions (P5 and P7) before the movement in the width direction of the intermediate transfer belt 71 is considerably small according to the configuration illustrated in FIG. 10B as compared to the configuration of FIG. 10A. In other words, the configuration illustrated in FIG. 10B can greatly reduce the movement of the primary transfer area B1 in the width direction of the intermediate transfer belt 71 as compared to the configuration illustrated in FIG. 10A.

As described above, according to the present exemplary embodiment, the steering roller 72 can be tilted with little movement of the primary transfer area B1 in the width direction, similarly as in the first exemplary embodiment. As a result, the deviation speed of the intermediate transfer belt 71 can be singularly controlled to be an arbitrary value. Deviation and meandering of the intermediate transfer belt 71 can thus be stably controlled, and the effect on color misregistration due to the steering operation can be reduced.

According to the present exemplary embodiment, the steering shaft 98 is arranged on the extension of the winding start generatrix L of the intermediate transfer belt 71 with respect to the steering roller 72. However, the present invention is not limited thereto, and the steering shaft 98 may only have to be offset to the primary transfer area B1 side from the rotational axis O of the steering roller 72. In other words, according to the present invention, it is only necessary that the tilt axis of the steering roller 72 is arranged on the predetermined area side of the belt from the rotational axis of the steering roller 72 when viewing in the tilt axis direction of the steering roller 72. If the offset amount is too large, it may increase the disturbance cause by the steering operation. In general, it is desirable to arrange the tilt axis of the steering roller 72 on the steering roller side from the roller adjacent to the steering roller on the image receiving position side when viewing in the tilt axis direction of the steering roller 72. Further, it is most desirable to arrange the tilt axis of the steering roller 72 at the position which is approximately the same as the extension of the winding start generatrix L of the intermediate transfer belt 71 with respect to the steering roller 72 when viewing in the tilt axis direction of the steering roller 72. This is as described in the present exemplary embodiment.

According to the present exemplary embodiment, the movement of the secondary transfer area B2 in the width direction becomes large similarly as in the first exemplary embodiment. However, the advantages according to the present exemplary embodiment are large for reasons similar to those described in the first exemplary embodiment.

According to the present exemplary embodiment, the accuracy of controlling deviation and meandering of the intermediate transfer belt 71 can be improved similarly as in the first exemplary embodiment, even when the steering shaft 98 is positioned at the rotational shaft end portion 72b of the steering roller 72. Further, the color misregistration caused by the steering operation can be reduced.

The present invention has been described above based on the specific exemplary embodiments. However, the present invention is not limited to the above-described exemplary embodiments.

For example, according to the above-described exemplary embodiments, the steering roller is arranged on the downstream side of the primary transfer portion, more specifically the downstream-most primary transfer portion, which is the image receiving position. However, it is not limited thereto, and the steering roller may be arranged on the upstream side of the primary transfer portion, more specifically the upstream-most primary transfer portion, which is the image receiving position. In other words, it is only necessary that at least one of the plurality of tension rollers for the belt is arranged on the upstream side or the downstream side of the image receiving position and to be tilted so that the arrangement angle with respect to the belt is changeable. According to the present invention, if the steering roller is arranged on the upstream side of the image receiving position, the area of the intermediate transfer belt from the steering roller to the primary transfer portion in the conveyance direction of the intermediate transfer belt corresponds to the “predetermined area” of the belt. In such a case, it is only necessary that the tilt axis of the steering roller is arranged on the predetermined area side, in the present invention, of the rotational axis of the steering roller when viewing in the tilt axis direction of the steering roller. Further, according to the present exemplary embodiment, the steering roller 72 is arranged on the downstream side of the image receiving surface D. However, the steering roller may be arranged on the upstream side of the image receiving surface D. For example, the driving roller 73 in the above-described exemplary embodiments may be employed as the steering roller. In other words, the driving roller 73 may also operate as the driving roller, or may only operate as the steering roller. In such a case, the tilt axis of the steering roller is offset to the primary transfer area B1 side from the rotational axis of the steering roller. Furthermore, the steering roller may be arranged on both the upstream and downstream sides of the image receiving position.

Further, if the steering roller is arranged on the upstream side of the image receiving position as described above, the detection unit for detecting the position of the belt in the width direction can be arranged between the steering roller and the image receiving position. Referring to the above-described exemplary embodiments, a similar sensor as in the above-described exemplary embodiment can be arranged between the driving roller 73 and the upstream-most primary transfer portion N1Y, for example, between the first driven roller 74 and the upstream-most primary transfer portion N1Y. It is desirable that such a detection unit detects the position of the belt in the width direction in the predetermined area of the belt according to the present invention, because the position of the belt in the width direction at the image receiving position which affects the color misregistration can be accurately detected by such a detection unit. Further, it is more desirable that at least one of the plurality of tension rollers of the belt is arranged between the steering roller and the detection unit in the predetermined area of the belt according to the present invention. In such a case, the effect of the steering operation on the detection result of the detection unit can be reduced by such an arrangement.

Furthermore, according to the above-described exemplary embodiments, the image forming apparatus is the tandem-type image forming apparatus employing the intermediate transfer method. However, it is not limited thereto. The present invention may also be applied to a single-drum type image forming apparatus and an image forming apparatus employing a direct transfer method. The single drum type image forming apparatus includes a plurality of developing units with respect to one image bearing member, and sequentially transfers to superimpose the plurality of toner images formed on the image bearing member onto the transferred material, and thus forms the image. The image forming apparatus employing the direct transfer method includes the transfer material carrying member which bears and carries the transfer material as a member to be transferred, instead of the intermediate transfer member. The direct transfer image forming apparatus thus directly transfers the toner image from the image bearing member to the transfer material on the transfer material carrying member. The direct transfer image forming apparatus can use the endless belt (i.e., a conveyance belt) similar to the intermediate transfer belt according to the above-described exemplary embodiments as the transfer material carrying member, and the belt conveyance apparatus having basically a similar configuration as that according to the above-described exemplary embodiments. Further, the transfer portion at which the image is transferred from the image bearing member to the transfer member on the transfer member carrying member becomes the image receiving position in the direct transfer image forming apparatus. Furthermore, the positional change of the transfer material carrying member on the image receiving position side rather than the steering roller is reduced in the direct transfer image forming apparatus. As a result, the accuracy of controlling deviation and meandering of the belt and color matching can be improved, similarly as in the above-described exemplary embodiments.

Moreover, if a plurality of image forming units is provided, the number of image forming units is not limited to that according to the above-described exemplary embodiments. Further, the image forming apparatus is not limited to the color image forming apparatus, and may be a monochrome image forming apparatus including a single image forming unit.

Furthermore, according to the above-described exemplary embodiments, the tilt axis of the steering roller is arranged at approximately the center of the belt in the width direction or at one end of the belt in the width direction. However, the tilt axis of the steering roller may be arranged at an arbitrary position in the end portion side of the belt in the width direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-193444 filed Sep. 18, 2013, which is hereby incorporated by reference herein in its entirety.

What is claimed is:

1. A belt conveyance apparatus comprising:
an image forming unit;
an endless belt configured to be movable and receive an image from the image forming unit directly or across a transfer material on an image receiving surface;
a plurality of rollers configured to stretch the belt and including a first roller and a second roller that stretch the image receiving surface respectively on an upstream side and a downstream side in a moving direction of the belt;
a steering roller configured to stretch the belt at a first position adjacent to the upstream side of the first roller or a second position adjacent to the downstream side of the second roller, and change a position of the belt in a width direction intersecting the moving direction of the belt by being tilted; and
a tilting mechanism configured to tilt the steering roller around a tilt axis, wherein the tilt axis is arranged, in a case where an area of the belt between the steering roller and the image receiving surface in a conveyance direction of the belt is a predetermined area when the steering roller is arranged at the first position, or in a case where an area of the belt between the steering roller and the image receiving surface in an opposite direction of the conveyance direction of the belt is a predetermined area when the steering roller is arranged at the second position, on the predetermined area side of the belt of a rotational axis of the steering roller when viewing in a direction of the tilt axis.

2. The belt conveyance apparatus according to claim 1, wherein the tilt axis is arranged at a position that approximately coincides with a line formed at a winding start position of the belt with respect to the steering roller on the predetermined area side or an extension thereof, when viewing in the direction of the tilt axis.

3. The belt conveyance apparatus according to claim 1, wherein the tilt axis is arranged at an approximate center of the belt in the width direction.

4. The belt conveyance apparatus according to claim 1, wherein the tilt axis is arranged at one end in the width direction of the tilt mechanism.

5. The belt conveyance apparatus according to claim 1, further comprising a detection unit configured to detect a position of the belt in the width direction.

6. The belt conveyance apparatus according to claim 5, wherein the detection unit is arranged in the predetermined area.

7. The belt conveyance apparatus according to claim 5, wherein the first roller or the second roller is arranged between the steering roller and the detection unit on the predetermined area side.

8. The belt conveyance apparatus according to claim 1, wherein the belt is an intermediate transfer member on which toner images of a plurality of colors are sequentially transferred, or a transfer material conveying member which carries and conveys a transfer material on which toner images of a plurality of colors are sequentially transferred.

9. An image forming apparatus including the belt conveyance apparatus according to claim 1.
